(19) United States
(12) Patent Application Publication
(10) Pub. No.: US 2024/0429614 A1
(43) Pub. Date: Dec. 26, 2024

(54) BASIC RADIATING UNIT OF ANTENNA FOR MILLIMETER WAVE OR ABOVE FREQUENCY BAND

(71) Applicant: ZHEJIANG LAB, Hangzhou City, Zhejiang Province (CN)

(72) Inventors: PREM NARAYAN CHOUBEY, Hangzhou City, Zhejiang Province (CN); Kuiwen XU, Hangzhou City, Zhejiang Province (CN); Xiaoyan LI, Hangzhou City, Zhejiang Province (CN); Xianbin YU, Hangzhou City, Zhejiang Province (CN)

(21) Appl. No.: 18/258,545

(22) PCT Filed: May 9, 2023
(86) PCT No.: PCT/CN2023/093043

§ 371 Date: Jun. 20, 2023

(51) Int. Cl. H01Q 9/28; H01Q 1/38; H01Q 9/06

(52) U.S. Cl. CPC H01Q 9/285; H01Q 1/38; H01Q 9/065

(57) ABSTRACT

The present disclosure relates to communications technologies, and provides a single polarized ME dipole and a basic radiator of a phased array antenna for millimeter wave or above frequency band. The radiator is an “array of the ME dipoles” with higher dielectric constant, and can be manufactured with the multilayer PCB or LTCC process. The ME dipole comprises an electric dipole made by two parts of a first metal sheet located on a top substrate layer, a magnetic dipole made by first vias connected to the first metal sheet and a third metal sheet located on a bottom substrate layer, a balun made by an other part of the first metal sheet and a third via, and a reflecting part made by a part of the third metal sheet. The substrate layers are stacked in a multilayer structure to facilitate arranging the metal sheets and the vias.

### TECHNICAL FIELD

Embodiments of the present invention relate to the field of communications technologies, particularly, relate to designing a basic radiating unit of a phased array antenna for millimeter wave or above frequency band with high gain.

### BACKGROUND

The wireless data traffic is ever growing and is predicted to maintain the exponential growth pattern within the next decade. The academia and industries are being motivated by this prediction to look beyond contemporary wireless standards and conceptualize the sixth-generation (6G) wireless networks. Among various promising solutions, terahertz (THz) based communications has been sincerely considered as highly likely technology for the 6G and beyond era.

The THz band is a set of frequencies above 300 GHz, and the 90-300 GHz frequency range has been categorized as sub-THz band. The sub-THz band can unleash vast amounts of new spectrum and thereby is promised to provide enormous data rates. Due to the limited range of such sub-THz band, data transmissions in the sub-THz band would be limited to very specific scenarios in which extreme data rates and/or low latency in local areas are required. Nevertheless, lower frequency bands will remain extremely important and may be the essential spectrum for coverage, capacity, and mobility in the 6G era. Although, sending signals across the THz band has been proven, doing so at a great distance has been all but challenging. It is because, the higher the frequency, the shorter the distance the signal can be transmitted. In view of this, it is expected to begin the sub-THz deployments from the lower edge of the sub-THz band, so to fully utilize the propagation characteristics of lower sub-THz frequencies and also allow the equipment ecosystem for higher bands to reach required maturity in a relative long time.

As the marco, micro, pico and even femto cell level development has already happened in 5G era, what really missing is the ultra reliable, high data rate transmission over very short distance (i.e., the localized communication) with very low latency. The application scenario could be taken as the Virtual Reality (VR) Head Mount Display (HMD) communicating with its console, the communication between the “master computer and the slave robots or the robotic arms” in manufacturing units, where the high precision and low latency is critical. In these cases, due to the short distance of communication, the equipment size should be significantly small and the sensing should be achieved through beam forming. However, designing beam forming antennas over such higher frequency poses a real challenge, as these antennas should be designed over substrate material in a planner and periodic manner by higher level RF components integration, while the higher the frequency, the higher the dielectric loss of the conventional substre material is.

On the other hand, using the ceramic materials with LTCC (low-temperature co-fired ceramic) process may offer many advantages, including high integration capability for passive devices and low cost, and thus may be well suited for high volume production.

The purpose of providing this background information is to reveal information that the applicant believes may be relevant to this application. It is not necessarily intended or interpreted as acknowledging that any of the aforementioned information constitutes prior art in relation to this application.

### SUMMARY

According to embodiments of the present invention, a multilayer substrate based dipole is provided, and an array of the dipoles in a size smaller than 70 percent of the free space wavelength is also provided. Where, the array of the dipoles can be manufactured by using standard photolithography or through LTCC/HTCC (high-temperature co-fired ceramic) techniques. In this way, when the array of the dipoles is taken as a basic radiating unit of a phased array antenna for millimeter wave or above frequency band (for example, 100 GHz), the impedance and the radiation bandwidth of the basic radiating unit is relatively wider, for example exceeding over 25 percent of the normal specification.

The multilayer substrate based dipole of the disclosed embodiments is a magnetoelectric (ME) dipole which comprises radiating arms and shorting vias, wherein the radiating arms represent an electric dipole and the shorting vias represent a magnetic dipole. The dipole further comprises a set of vias and microstrip line to realize a baulun for feeding the dipole.

According to a first aspect of the disclosure, a single polarized ME dipole is provided as comprising: an electric dipole made by two parts of a first metal sheet located on a top substrate layer; a magnetic dipole made by first vias connected to the first metal sheet and a third metal sheet located on a bottom substrate layer, wherein a middle substrate layer is sandwitched between the top substrate layer and the bottom substrate layer; a balun for feeding the ME dipole, wherein the balun comprises a horizontal section made by an other part of the first metal sheet and a vertical section made by a third via, the third via is connected to a part of a second metal sheet located on the middle substrate layer; and a reflecting part made by a part of the third metal sheet. Where, the top substrate layer, the middle substrate layer and the bottom substrate layer are stacked in a multilayer structure to facilitate arranging the first metal sheet, the second metal sheet, the third metal sheet, the first via and the third via.

To achieve a stable impedance bandwidth with a relatively higher gain and a relatively lower cross polarization, an array of the above ME dipoles (also named as dipole array) has been designed as a basic radiating unit (also named as radiator or dipole based radiator) of a phased array antenna for millimeter wave or above frequency band. The dipole array comprises a number of the above ME dipoles arranged in an array and may be fed from the center through a power divider and the corresponding feeding phase is balanced by selecting a right feeding point. A region of the array is of a multilayer structure to facilitate arranging metal sheets and vias. The dipole array is relatively smaller in size and can be taken as the basic radiating unit of the phased array antenna.

According to the embodiments of the present invention, the dipole based radiator is designed with a multilayer structure in which the feeding part and the radiating part are separated by a metallic ground layer sandwitched between the middle substrate and the bottom substrate and are electricly connected through a coaxial line formed by vias. This arrangement significantly reduces the influence of the feeding part on the radiating part of the radiator and the vice versa.

### BRIEF DESCRIPTION OF THE DRAWINGS

To describe the technical solutions in the embodiments of the present invention more clearly, the following briefly introduces the accompanying drawings of the embodiments. Apparently, the accompanying drawings in the following description show merely some embodiments of the present invention, and a person of ordinary skill in the art may still derive other drawings from these accompanying drawings without creative efforts.

FIG. 1 is a schematic depiction of a multilayer structural arrangement used to realize a basic radiating unit of a phased array antenna according to embodiments of the present invention.

FIG. 2 is a schematic depiction from the top view of a single polarized dipole designed over the multilayer structural arrangement as shown in FIG. 1.

FIG. 3 is a schematic depiction of the single polarized dipole from shown in FIG. 2, observed from X axis.

FIG. 4 is a schematic depiction of the single polarized dipole from shown in FIG. 2, observed from Y axis.

FIG. 5 is a schematic depiction of the single polarized dipole from FIG. 2, observed from the 3D angle.

FIG. 6 is a schematic depiction, observed from the top, of a dipole based radiators from FIG. 2.

FIG. 7 is a schematic depiction, observed from the 3D angle, of a dipole based radiator shown in FIG. 6.

FIG. 8 is a schematic depiction, observed from X axis, of a dipole based radiator shown in FIG. 6.

FIG. 9 is a schematic depiction, observed from Y axis, of a dipole based radiator shown in FIG. 6.

FIG. 10 is a return loss graph of the dipole based radiator from FIG. 6.

FIG. 11 is a radiation gain pattern of the dipole based radiator from FIG. 6.

| Reference signs | Component | Functioning as |
|---|---|---|
| 401a, 401b, 602a, 602b, 702, 802a, | first via | magnetic dipole |
| 802b, 901, 102a, 102b, 102c, 102d, | | |
| 1101 | | |
| 403, 603, 703, 803, 903, 103a, 103b, | third via | balun |
| 1103 | | |
| 404, 904, 1004, 1104 | forth via | coaxial feed line |
| 411, 611, 711, 811, 1011, 1111 | top substrate layer | |
| 412, 612, 712, 812, 1012, 1112 | middle substrate layer | |
| 413, 613, 713, 813, 1013, 1113 | bottom substrate layer | |
| 421, 503a, 503b, 621, 721, 821a, 821b, | first metal sheet | electric dipole |
| 921a, 921b, 921c, 921d, 1121, 1021a, | | |
| 1021b | | |
| 619, 719, 819, 919a, 919b, 1119 | first metal sheet | balun |
| 422, 501, 502, 622, 722, 822, 922, | second metal sheet | feed line of balun, |
| 1022, 1122 | | power divider |
| 423, 623, 723, 823, 923, 1023, | third metal sheet | reflecting part |
| 1123 | | |
| 424 | forth metal sheet | |
| 631, 731, 831 | feeding point | |

### DETAILED DESCRIPTION OF THE EMBODIMENTS

The following clearly and completely describes the technical solutions in the embodiments of the present invention with reference to the accompanying drawings. Apparently, the described embodiments are merely a part rather than all embodiments of the present invention. All other embodiments obtained by a person of ordinary skill in the art based on the embodiments of the present invention without creative efforts shall fall within the protection scope of the present invention.

An embodiment of the present invention provides a multilayer substrate arrangement to realize a single polarized dipole such that a dipole based radiator can be realized with an array of two or more single polarized dipoles and work as a basic radiating unit of a phased array antenna over the millimeter wave and the THz.

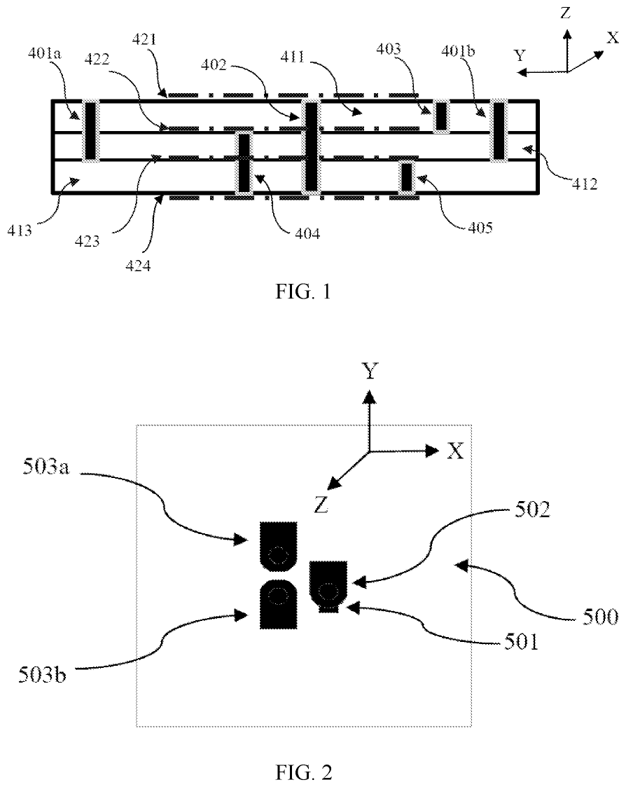

FIG. 1 illustrates a schematic structural view of a multilayer structure in which substrate layers are stacked over one and another to facilitate arranging metal sheets and vias, and the metal sheets and vias are used to realize an array of dipoles as the basic radiating unit of a phased array antenna. Here the thickness of each of the substrate layers is chosen from a fixed set of options provided by the suppliers, and the antenna design specification plays an important role in making such selection. The vias facilitate interlayer connections of the stacked substrate layers and may also be used to shield the leakage of electromagnetic radiations. In the disclosed embodiment, various vias from the blind vias to through vias and the buried vias may be used.

As shown in FIG. 1, three substrate layers, which include a top substrate layer 411, a middle substrate layer 412, and a bottom substrate layer 413, are used to facilitate arranging four metal sheets. Specifically, a first metal sheet 421 provided on the top surface of the top substrate layer 411 is for realizing the radiating part of this dipole based radiator, a second metal sheet 422 provided on the top surface of the middle substrate layer 412 or sandwitched between the top substrate layer 411 and the middle substrate layer 412 is for realizing the feed line of this dipole based radiator, a third metal sheet 423 provided on the top surface of the bottom substrate layer 413 or sandwitched between the middle substrate layer 412 and the bottom substrate layer 413 is for realizing the reflecting part (also named as reflector) of this dipole based radiator, and a forth metal sheet 424 provided on the back surface of the bottom substrate layer 413 is for realizing the feeding part from backward side of this dipole based radiator. The feeding part from backward side may come from a RF chain or a power dividing network if a large array of dipoles is realized. Two or more first vias 401a, 401b are used to connect the third metal sheet 423 and the first metal sheet 421 and to form the magnetic dipoles of the dipole based radiator. At least one second via 402 is used to connect all the metal sheets 421, 422, 423, and 424. At least one third via 403 is, in its current form, used to connect the first metal sheet 421 and the second metal sheet 422 for realizing the baluns to feed the dipole based radiator. At least one forth via 404 is used to transfer the electromagnetic (EM) signal from the feeding part (such as a part of the third metal sheet 423 working as a source) in the bottom substrate layer 413 to the radiating part (such as some parts of the first metal sheet 421 and the second metal sheet 422 working as a radiator) in the top substrate layer 411, where the bottom substrate layer 413 and the top substrate layer 411 are separated by the middle substrate layer 412. The forth via 404 may be surrounded by a set of fifth vias 405 to form a coaxial line for shielding EM energy from leakage. When needed, the fifth vias 405 may also be used to guard the feed line extended from the second metal sheet 422. Further, when needed, one or more additional substrate layers can be stacked on the bottom surface of the bottom substrate layer 413 to support the RF or optical components of this dipole based radiator.

The three substrate layers can have the same or different thickness, depending on the design planning of the designer, for a basic radiating unit of the phased array antenna. The engineering of the first metal sheet over the top substrate layer plays the role of the dipole's radiating arm and can also be the part to form the horizontal section of the balun for feeding the dipole. The blind first vias penetrated the top substrate layer and the middle substrate layer for connecting the first metal sheet over the top substrate layer to the third metal sheet sandwiched between the middle substrate layer and the bottom substrate layer, work as a reflector for the disclosed ME dipole based radiator. The radius of such first vias is in proportion to the operating frequency (f₀) and limited by the manufacturing capabilities of the supplier's equipment. The staggered third via penetrates the top substrate layer working as the vertical section of the balun. In the disclosed embodiment, depending on the radiator's engineering, there could have one or two such third vias on one or both ends of the horizontal section of the balun.

The second metal sheet sandwitched between the top substrate layer and the middle substrate in the form of the microstrip line exploited as the feed line of the balun of the dipole-based radiator engineered (its size and the orientation with respect to the dipole's radiating arms) in an optimal manner considering the impedance of the radiating unit and the radiation pattern key performance indicators including the cross polarization discriminator (XPD). The dipole-based radiator, if duplicated and placed in proximity of the original one, its array has been formed. The total size of this array has been maintained below 0.7 times of the wavelength at f₀.

FIG. 2 illustrates a top view on XY plane of a single polarized dipole designed over the multilayer structural arrangement as shown in FIG. 1. As shown in FIG. 2, the dipole 500 includes radiating arms 503a, 503b and the horizontal section of the balun 502. Where, the radiating arms 503a, 503b are made by parts of the first metal sheet and are for forming electric dipole of the dipole. The balun 502 is also made by a part of the first metal sheet. The feeding to the balun 502 is provided through the microstrip line 501, and the microstip line 501 is made by a part of the second metal sheet. The reflecting part (not visiable in FIG. 2) of the dipole 500 is formed by the metallic ground layer sandwitched between the middle substrate layer and the bottom substrate layer in the multilayer structural arrangement as shown in FIG. 1.

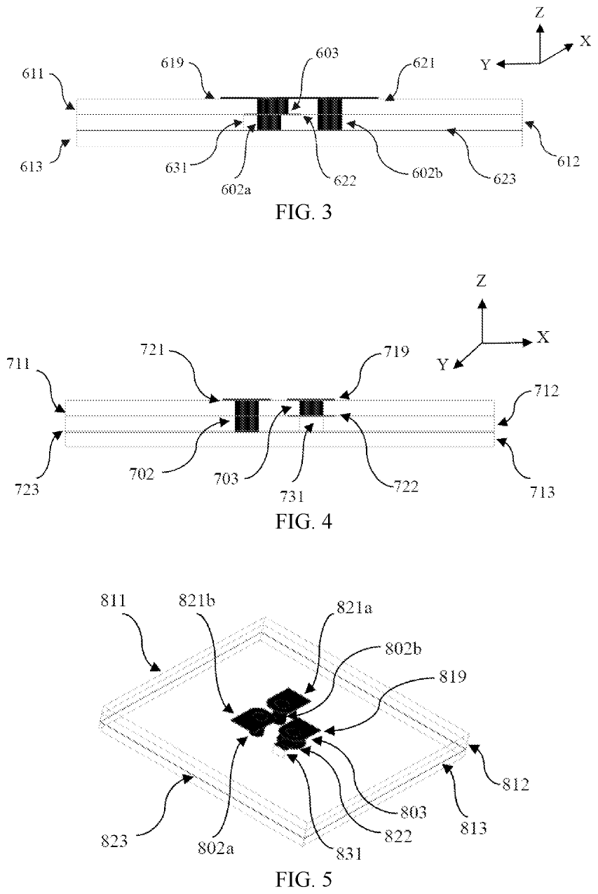

FIG. 3 illustrates a side view of the disclosed single polarized dipole on YZ plane. The dipole is a ME dipole based on metal interactions over substrate layers 611, 612, 613 in the multilayer structural arrangement as shown in FIG. 1. The ME dipole comprises an electric dipole and a magnetic dipole. The thickness of the substrate layers 611, 612, 613 is about 0.127 mm. However, different substrate thickness could be adopted without departing from the scope of the present invention. In FIG. 3, a pair of first vias (for example, in the form of through vias) 602a, 602b are used to realize the magnetic dipole of the ME dipole, and a part of the first metal sheet 621 is used to realize the electric dipole of the ME dipole. A part of the second metal sheet 622 in the form of microstrip line is used to feed the ME dipole through a balun made of the third via 603 and another part of the first metal sheet 619. In this way, the microstrip line 622 may also be named as feed line of the balun or a vertical section of the balun. A part of the third metal sheet 623 is functioning as the reflector of the ME dipole. The feeding point 631 may be located on the middle substrate layer 612 as an extension of the microstrip line 622. In another embodiment, the feeding point 631 may be located on the bottom substrate layer 613 (specifically, on the bottom surface of the middle substrate layer 612 away from the microstrip line 622). This realocation of the feeding point 631 can be achieved through a transition from the coaxial line to the microstrip line 622.

FIG. 4 illustrates a side view of the disclosed single polarized dipole on XZ plane. The dipole is a ME dipole based on metal interactions over substrates 711, 712 and 713 and comprises an electric dipole and a magnetic dipole. As shown in FIG. 4, a part of the third metal sheet 723 is used for forming the reflecting part of the disclosed ME dipole. A pair of first vias 702 are used for forming the magnetic dipole of the ME dipole, a pair of parts of the first metal sheet 721 are used for forming the electric dipole of the ME dipole. Another part of the first metal sheet 719 and a part of the second metal sheet (in the form of the microstrip line) 722 are used to realize the balun for feeding the ME dipole. The part of the first metal sheet 719 and the microstrip line 722 are connected through the third via 703. The feeding point 731 can be a further extension of the microstrip line 722 or a transition between the coaxial line and the microstrip line 722.

FIG. 5 illustrates a 3 dimensional (3D) view of the disclosed single polarized dipole. The dipole is a ME dipole comprising an electric dipole and a magnetic dipole. As shown in FIG. 5, the first vias 802a, 802b are used for realizing the magnetic dipole of the ME dipole. Two parts of the first metal sheets 821a, 821b are drawn over the top surface of the top substrate layer 811 (may be made of a material comprising Ferro A6M-E) as radiating arms and are used to form the electric dipole of the ME dipole. The third metal sheet 823 sandwitched between the bottom substrate layer 813 and the middle substrate layer 812 is provided with slots for accommodating coaxial feed lines. A part of the second metal sheet 822 sandwitched between the middle substrate layer 812 and the top substrate layer 811 is used to realize the feed line to the balun of the ME dipole. For example, a part of the second metal sheet 822 in the form of microstrip line is connected to another part of the first metal sheet 819 on the top substrate layer 811 and the third via 803 (in the form of through via while not clearly visible in FIG. 5), where the part of the first metal sheet 819 and the third via 803 are used to realized the balun to feed the ME dipole. The feeding point 831 could be an extension of the microstrip line 822 or a transition from the coaxial junction to the third metal sheet 823 on the bottom substrate layer 813.

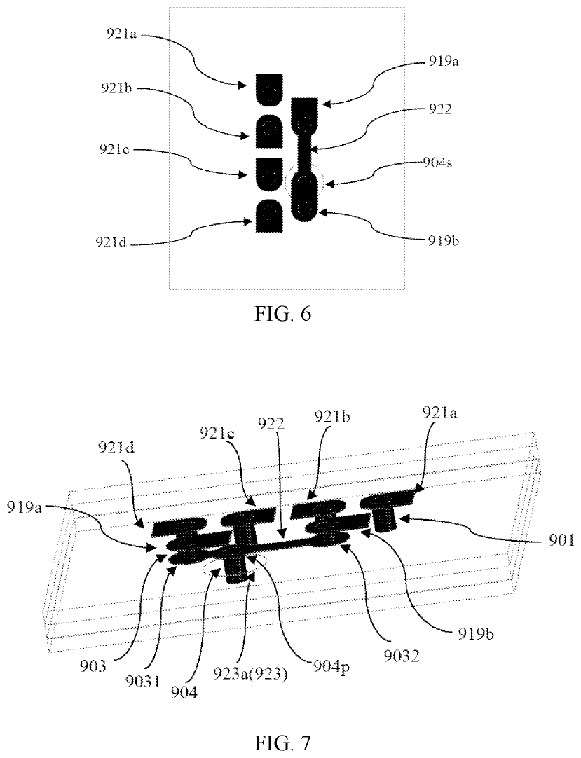

FIG. 6 illustrates a projection of an array of the ME dipoles as shown in FIG. 2 to FIG. 5 on XY plane. As an exemplary embodiment, the array is made over the multilayer structural arrangement as shown in FIG. 1, where the substrate layers may be made of a material comprising Ferro A6M-E. If the high dielectric constant substrate layer is applied, the size of the dipole array would be smaller than 0.65 times of the free space wavelength, such that the dipole array could be considered as the basic radiating unit of a phased array antenna in a relatively large size to achieve a relatively higher gain, and thus the dipole array may also be named as a dipole based radiator. The slot 904s in the array region is used to accommodate a coaxial feed line transition for jointing the feed line 922 in the top substrate layer and the feed line in the bottom substrate layer (that is invisible in such arrangement shown in FIG. 6). This dipole based radiator includes two dipoles as shown in FIG. 2 to FIG. 5 which are designed over a multilayer structural arrangement as illustrated in above FIG. 1. In the array region, each one dipole based raditor is made of a pair of dipoles in a 1×2 array and thus may also be named as dipole array. Each one dipole in the dipole array includes a pair of radiating units (921a, 921b), (921c, 921d) and a balun 919a, 919b. The baluns 919a, 919b of the two adjacent dipoles are connected by the feed line 922 and the coaxial feed line transition accommodeated in the slot 904s.

FIG. 7 illustrates a 3D view of the dipole array shown in FIG. 6, which comprises two ME dipoles in a 1×2 array and can work as a basic radiating unit of a phased array antenna. In this view, the components of the array are visible more clearly. As shown in FIG. 7, four first vias 901 are used for forming the magnetic dipoles of the two ME dipoles in the dipole array. Some parts of the first metal sheets 921a and 921b are used for forming the electric dipole of one ME dipole while some other parts of the first metal sheets 921c and 921d are used for forming the electric dipole of another ME dipole. Some further parts of the first metal sheets 919a, 919b are used to form the horizontal sections of the baluns for feeding the two ME dipoles on the left and on the right, respectively. Third vias 903 are used to form the vertical sections of the baluns. Pads 9031 and 9032 for the third vias 903 are complementary around the right side of the respective ME dipoles. A part of the second metal sheet 922 in the form of microstrip line is connected to the third vias 903 and thus may also be named as the feed line to balun. The feed line 922 between the two ME dipoles can also be working as the power divider and the phase compensating unit of the dipole array when the dipole array workes as a phased array antenna. A part of the third metal sheet 923 accommodateed in a slot 923a provided in the middle substrate layer is working as the reflecting part of the dipole array. The slot 923a is further used to accommodate the coaxial feed line as an inner conductor of the respective ME dipoles. The coaxial feed line is realized by the forth via 904, and the forth via 904 may be surrounded by a pad 904p.

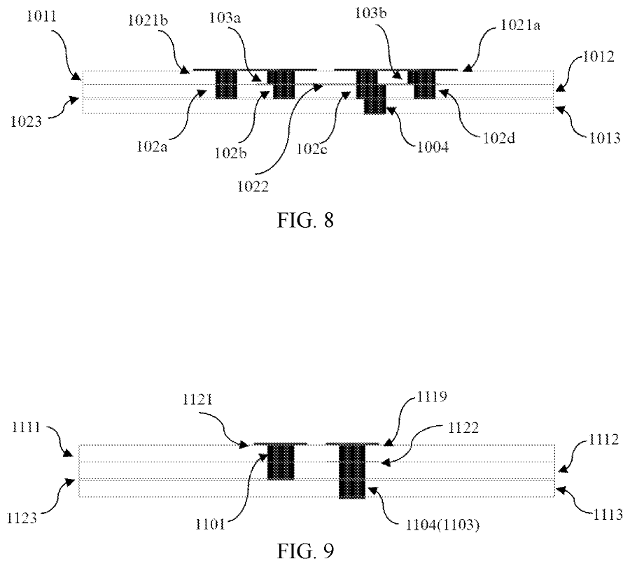

FIG. 8 illustrates a side view of the dipole array shown in FIG. 6 on YZ plane. The first vias 102a and 102b are used for realizing the magnetic dipole of the left ME dipole in the dipole array, while the first vias 102c and 102d are used for realizing the magnetic dipole of the right ME dipole in the same dipole array. These series of first vias 102a, . . . , 102d are shorted to the middle substrate layer 1012. Some parts of the first metal sheets 1021a, 1021b located on the top substrate layer 1011 are used for forming respective electric dipoles of the two ME dipoles in the array. The third vias 103a, 103b are used for forming respective baluns of the two ME dipoles, by being connected to the power divider 1022 in the form of microstrip line and some other parts than the parts realizing the electric dipoles of the first metal sheet 1021a, 1021b located on the top substrate layer 1011. The power divider 1022 in the form of microstrip line is printed on the middle substrate layer 1012, and may be also working as a phase balancer between the two ME dipoles, so to achieve the optimal radiation performance of the dipole array antenna. The forth via 1004 is used as an inner conductor of the coaxial transition which is used to connect the radiating part realized with the first metal sheet on the top substrate layer 1011 to the top of the reflecting part 1023 and the RF circuitry printed on the bottom substrate layer 1013.

FIG. 9 illustrates a side view of the disclosed dipole array as shown in FIG. 6 on XZ Plane. As shown in FIG. 9, a part of the second metal sheet 1122 in a form of microstrip line printed on the middle substrate layer 1112 or sandwiched between the top substrate layer 1111 and the middle substrate layer 1112 is working as the power divider between two basic dipoles in the dipole array. Some parts of the first metal sheet 1121 are used for forming the electric dipoles of respective ME dipoles in the dipole array. The parts of the first metal sheet 1121 working as electric dipoles are connected through first vias 1101. The first vias 1101 are used for forming the magnetic dipoles of respective ME dipoles in the dipole array. The forth via 1104 is for forming a coaxial junction between the power divider 1122 and a part of the third metal sheet 1123 located on the bottom substrate layer 1113. The third vias 1103 may not be visibly distinct from the forth vias 1104 with their projection on the XZ plane are overlapped. Nevertheless, the third via 1103 is only existing between top substrate layer 1111 and the middle substrate layer 1112. The third via 1103 is for forming the balun to feed the ME dipole. Another part of the first metal sheet 1119 as a pad of the third via 1103 is also working as a part of the balun. The physical spacing between the balun and the ME dipole is a variable and can be exploited to improve the electrical parameter of the ME dipole array working as a basic radiating unit of a phased array antenna. The thickness of parts of the first metal sheet 1121, 1119 can be optimized to improve electrical and radiation performance, including the working frequency of the ME dipoles in the dipole array working as a phased array antenna.

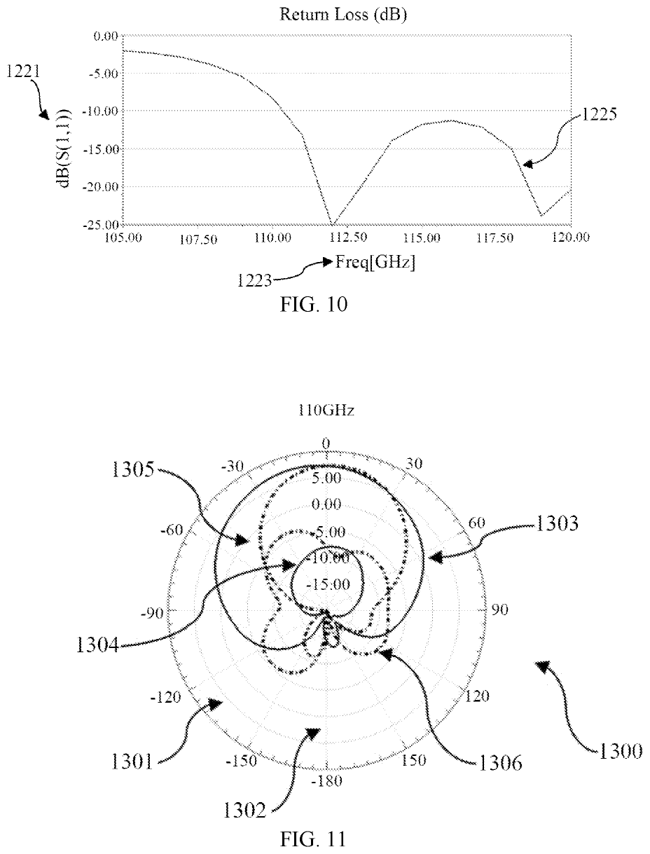

FIG. 10 illustrates a return loss performance of the exemplary dipole array as shown in FIG. 6 to FIG. 9. The variable S-parameter 1221 is indicated on the vertical axis with a scale of 5 dB. The variable working frequency 1223 in GHz is indicated on the horizontal axis with a scale of 2.5 GHz. For the dipole array, its return loss changes as its working frequency changes. More particularly, along with the working frequency changing, the return loss shows a change as shown by the curve 1225.

FIG. 11 illustrates a radiation gain pattern, indicating the gain with respect to omnidirectional antenna over 110 GHz, of the exemplary dipole array antenna as shown in FIG. 6 to FIG. 9. The radiation patten plot 1300 is divided into annular regions 1301 by circles with a scale of 5 dB gain difference, and divided into sector regions 1302 by lines with a scale of 30 degree phase angle. By comparing the main polarization gain graph 1303 in horizontal plane (H-Plane), the cross polarization gain graph 1304 in H-plane, the main polarization gain graph 1305 in vertical plane (V-Plane) and the cross polarization gain graph 1306 in V-plane, it can be seen that the cross polarization gain level is below −15 dB from the level of co-polarization. This level difference can be improved by optimizing the physical structure and the parameters of the metallic parts forming ME dipole.

1. A single polarized magnetoelectric (ME) dipole comprises:
an electric dipole made by two parts of a first metal sheet located on a top substrate layer;
a magnetic dipole made by first vias connected to the first metal sheet and a third metal sheet located on a bottom substrate layer, wherein a middle substrate layer is sandwitched between the top substrate layer and the bottom substrate layer;
a balun for feeding the ME dipole, wherein the balun comprises a horizontal section made by an other part of the first metal sheet and a vertical section made by a third via, the third via is connected to a part of a second metal sheet located on the middle substrate layer; and
a reflecting part made by a part of the third metal sheet,
wherein the top substrate layer, the middle substrate layer and the bottom substrate layer are stacked in a multilayer structure to facilitate arranging the first metal sheet, the second metal sheet, the third metal sheet, the first vias and the third via.

2. The single polarized ME dipole of claim 1, wherein the horizontal section of the balun is printed on the middle substrate layer in a form of microstrip line.

3. The single polarized ME dipole of claim 2, wherein the microstrip line is further extended to a coaxial feed line from another plane.

4. The single polarized ME dipole of claim 1, wherein the two parts of the first metal sheet for forming the electric dipole are in a form of a pair of arms.

5. The single polarized ME dipole of claim 1, wherein the top substrate layer, the middle substrate layer and the bottom substrate layer have a same thickness or are of different thickness.

6. The single polarized ME dipole of claim 1, wherein the ME dipole further comprises a second via to connect all the first metal sheet, the second metal sheet and the third metal sheet.

7. The single polarized ME dipole of claim 1, wherein the ME dipole further comprises a forth via to transfer an electromagnetic signal from a feeding part comprising a part of the third metal sheet to a radiating part comprising some parts of the second metal sheet.

8. A basic radiating unit for a phased array antenna over millimeter wave or above frequency band, comprising a number of ME dipoles arranged in an array, wherein
a region of the array is of a multilayer structure to facilitate arranging metal sheets and vias,
each of the ME dipoles comprises:
an electric dipole made by two parts of a first metal sheet located on a top substrate layer;
a magnetic dipole made by first vias connected to the first metal sheet and a third metal sheet located on a bottom substrate layer, wherein a middle substrate layer is sandwitched between the top substrate layer and the bottom substrate layer;
a balun for feeding the ME dipole, wherein the balun comprises a horizontal section made by an other part of the first metal sheet and a vertical section made by a third via, the third via is connected to a part of a second metal sheet located on the middle substrate layer; and
a reflecting part made by a part of the third metal sheet,
the horizontal section of the baluns between two adjacent ME dipoles works as a power divider of the basic radiating unit.

9. The basic radiating unit of claim 8, wherein the horizontal section of the balun is printed on the middle substrate layer in a form of microstrip line.

10. The basic radiating unit of claim 8, wherein the power divider further works as a phase balance between the two adjacent ME dipoles.

11. The basic radiating unit of claim 8, a total size of the array has been maintained below 0.7 times of a wavelength at f₀.

12. The single polarized ME dipole of claim 2, wherein the two parts of the first metal sheet for forming the electric dipole are in a form of a pair of arms.

13. The single polarized ME dipole of claim 3, wherein the two parts of the first metal sheet for forming the electric dipole are in a form of a pair of arms.

14. The single polarized ME dipole of claim 2, wherein the top substrate layer, the middle substrate layer and the bottom substrate layer have a same thickness or are of different thickness.

15. The single polarized ME dipole of claim 3, wherein the top substrate layer, the middle substrate layer and the bottom substrate layer have a same thickness or are of different thickness.

16. The single polarized ME dipole of claim 4, wherein the top substrate layer, the middle substrate layer and the bottom substrate layer have a same thickness or are of different thickness.

17. The single polarized ME dipole of claim 2, wherein the ME dipole further comprises a second via to connect all the first metal sheet, the second metal sheet and the third metal sheet.

18. The single polarized ME dipole of claim 2, wherein the ME dipole further comprises a forth via to transfer an electromagnetic signal from a feeding part comprising a part of the third metal sheet to a radiating part comprising some parts of the second metal sheet.

19. The basic radiating unit of claim 9, wherein the power divider further works as a phase balance between the two adjacent ME dipoles.

20. The basic radiating unit of claim 9, a total size of the array has been maintained below 0.7 times of a wavelength at f₀.
